(19) United States
(12) Patent Application Publication
(10) Pub. No.: US 2012/0264421 A1
(43) Pub. Date: Oct. 18, 2012

(54) METHOD AND EQUIPMENT FOR WIRELESS COMMUNICATION

(76) Inventor: Jing Liu, Shenzhen City (CN)

(21) Appl. No.: 13/394,218

(22) PCT Filed: Aug. 31, 2010
(86) PCT No.: PCT/CN2010/076497

§ 371 Date: May 21, 2012

(30) Foreign Application Priority Data
Sep. 3, 2009 (CN) 200910092207.5

(51) Int. Cl. H04W 88/06; H04W 76/02

(52) U.S. Cl. 455/426.1; 455/422.1

(57) ABSTRACT

The invention provides a method for wireless communication. The method comprises the following steps: a wireless transceiver obtains user information from a SIM card, wherein the user needs to connect with a mobile communication network; the wireless transceiver establishes communication link with local terminal equipment to receive and transmit data of the user, and establishes a wireless communication link with the mobile communication network to receive and transmit data of the user; and the wireless transceiver receives data transmitted from the local terminal equipment, forwards the data to the mobile communication network, receives the data which is transmitted by the mobile communication network to the user, and forwards the data to the local terminal equipment. The invention further provides a wireless transceiver. By providing a unified bottom communication platform for the user, the technical solutions provided by the embodiments of the present invention solve the problem that the user should change terminal equipment when communicating with different communication systems.

### FIELD OF THE INVENTION

The invention relates to the field of wireless communication, and more particularly, to a method and equipment for wireless communication.

### BACKGROUND OF THE INVENTION

With the continuous development of communication facility and communication technology in recent years, mobile communication has been widely applied, and the application of the mobile communication is also rapidly increased. In many fields, wireless communication equipment such as mobile phone, wireless laptop, PDA (Personal Digital Assistant) and the like is widely used and is used for transmitting voice, video and data via a wireless communication network.

At wireless communication service end which runs the wireless communication nets scheduled services for users of wireless communication equipment are provided in the manner of registering, authenticating, position updating, transferring, call route selecting, etc. For example, the GSM (Global System for Mobile Communication) provides user confirmation and identification, and encryption communication between the user and the other parts of the communication network. A subscriber identification module (SIM) card is a separable e-card which stores the IMSI (International Mobile Subscriber Identity) of the user, the subscriber authentication key Ki and Ciphering Key Kc of each user and the personal information such as a user telephone directory. The IMSI consists of an MCC (Mobile Country Code), an MNC (Mobile Network Code) and a particular user MSIN (Mobile Subscriber Identification Number). By a user account corresponding to the SIM card the portable SIM card is convenient for the user to change SIM card among GSM compatible equipments and to use the communication network continuously. One of key characteristics of the GSM is roaming service, so that the mobile user can automatically transmit and receive a voice call and information or enjoy other services including information service in the geographical areas beyond local network coverage. The roaming service needs mobile management, identification, authorization and a lot of accounting procedures among different service providing ends. The local network of the users is an HLR (Home Location Register) network logged by the mobile communication equipment. The network can confirm whether the station is registered to the HLR by the IMSI when the mobile communication equipment is started or is switched to the network. If yes, the network is the local network of the user and the communication is continued. If not, the accessed network intends to identify the local network of the equipment and makes a request for service information relevant to the mobile communication equipment. If a roaming agreement is not signed between the two services providing ends or the roaming is not allowed by the mobile communication equipment the accessed network refuses to provide the service. If the service is allowed the accessed network establishes a TMSI (Temporary Mobile Subscriber Identity) and starts to keep service record. The local network updates the information thereof and indicates that the mobile communication equipment is at a new host network, so that all transmitted information can be correctly transmitted in the accessed network. When a call is dialed to the roamed mobile communication equipment the PSTN (Public Switched Telephone Network) transmits the call to the local network of the mobile station and then to the accessed network

The problem above mentioned also exists in the different communication systems such as a CDMA (Code Division Multiple Access) system, a WCDMA (Wideband Code Division Multiple Access) system, a CDMA 2000 or a TD-SCDMA (Time Division-Synchronization Code Division Multiple Access) system, so that the system provides communication service to the different users by an SIM or UIM (User identification Module) card, wherein the SIM or UIM card can normally be the separable e-card which stores the IMSI of the user.

In current mobile terminals, such as majority of mobile phones, single card is used, i.e. only one physical slot is provided in the cell phone for the SIM card, in particular in the mobile phones with foreign brands. There is incompatibility among the mobile phones because of different wireless communication modes used by different communication companies. Although a mobile phone with double-cards exists in the prior art, the mobile phone is fewer in type, high in cost and narrow in application degree. For example, in order to use the local communication service, the user needs to change a new mobile phone or terminal equipment and use the new SIM or UIM card to access the communication network which is different from the formerly used communication network though the new mobile phone or terminal equipment in the case that the user leaves from the local network to be under the status of international roaming in a short time. Generally speaking, it means that the users have to pay a very high price to obtain a set of new mobile phone or terminal equipment. Furthermore, the user can not continuously use his familiar mobile phone or terminal equipment and has to spend time, energy and money to use a set of new mobile phone or terminal equipment. Of course, the cost is very high for the user to use the local communication service in a short time.

The user cares for the provided undifferentiated service and service quality rather than the specific communication mode of the used communication network. The different terminals have different consumer groups aiming at different user demands, i.e. the hobbies and the interests of the users who buy the terminals are different. Therefore, a technical solution which can lead the user to continuously use his favorite mobile terminal and to access different mobile communication systems rather than the limited local communication network by the usually-used mobile terminal and with a smaller cost simultaneously, does not exist in the prior art.

### SUMMARY OF THE INVENTION

The present invention aims at solving one of the technical defects by providing a unified communication platform for the user and particularly leading the user to continuously use the favorite mobile terminal, but at the same time have the ability to access different mobile communication systems simultaneously with a smaller companion device.

In order to achieve the aims, embodiments of the present invention provide a method for wireless communication, comprising the following steps: a wireless transceiver obtaining user information from a SIM card when the user needs to connect with a mobile communication network; the wireless transceiver establishing a communication link with a local terminal equipment to receive and transmit data of the user, and establishing a wireless communication link with the mobile communication network to receive and transmit the data of the user; and the wireless transceiver receiving data transmitted from the local terminal equipment and forwarding the data to the mobile communication network, and receiving the data transmitted from the mobile communication network to the user and forwarding the data to the local terminal equipment.

According to the embodiments of the present invention, the communication between the user and the mobile communication network comprises voice communication or data communication.

According to the embodiments of the present invention, the mobile communication network comprises one of the following communication systems: GSM (Global System for Mobile Communication), CDMA (Code Division Multiple Access) system, WCDMA (Wideband Code Division Multiple Access) system, CDMA 2000, TD-SCDMA (Time Division-Synchronization Code Division Multiple Access) system, WiFi (Wireless Fidelity) or a WiMax (WiMAX), and the wireless transceiver establishes a wireless link for communication between the user and the mobile communication network with the mobile communication network according to a communication mode defined by the mobile communication network.

According to the embodiments of the present invention, the communication link established between the wireless transceiver and the local terminal equipment comprises at least one of following communication links: a wireless communication link comprising Bluetooth communication link or infrared communication link; and a wire link connected by network line, telephone line or USB (Universal Serial Bus) interface data line.

According to the embodiments of the present invention, the local terminal equipment comprises terminal equipment with at least one of the following types: mobile phone, computer, PDA (Personal Digital Assistant) or MP4 (Media Player 4).

According to the embodiments of the present invention, the wireless transceiver forwards information of the voice communication of the user transmitted from the local terminal equipment to the mobile communication network after receiving the information of the voice communication; and forwards a voice communication data transmitted from the mobile communication network to the local terminal equipment after receiving the voice communication data; or the wireless transceiver forwards information of voice communication of the user transmitted from the mobile communication network to the local terminal equipment after receiving the information of voice communication; and forwards a voice communication data transmitted from the local terminal equipment to the mobile communication network after receiving the voice communication data.

According to the embodiments of the present invention, the wireless transceiver forwards information of data communication of the user transmitted from the local terminal equipment to the mobile communication network after receiving the information of data communication; and forwards a data communication data transmitted from the mobile communication network to the local terminal equipment after receiving the data communication data; or the wireless transceiver forwards the information of data communication the user transmitted from the mobile communication network to the local terminal equipment after receiving the information of data communication; and forwards the data communication data transmitted from the local terminal equipment to the mobile communication network after receiving the data communication data.

According to the embodiments of the present invention, the local terminal equipment outputs data which is transmitted from the mobile communication network to the user.

The embodiments of the present invention further provides a wireless transceiver, comprising a user identification unit, a remote transceiver unit and a local transceiver unit, wherein the user identification unit comprises a set of expansion slots for connecting with at least one of SIM cards, and the user identification unit is used for obtaining the user information from the subscriber identification module (SIM) cards when the user needs to connect with a mobile communication network; the remote transceiver unit is used for establishing the wireless link for communication between the user and the mobile communication network to receive and transmit the data of the user, and the wireless link carries data for communication between the user and the mobile communication network; and the local transceiver unit is used for establishing the communication link for communication between the wireless transceiver and the local terminal equipment to receive and transmit the data of the user, and the communication link carries data for communication between the user and the mobile communication network.

According to the embodiments of the present invention, the wireless transceiver further comprises a processor unit and a control unit, wherein the control unit comprises an operating system module, a voice transmission module, a telephone control module and a network communication module.

The operating system module is used for calling the voice transmission module by the processor unit and controlling voice data transmitted between the user and the mobile communication network; the operating system module is used for calling the telephone control module by the processor unit and controlling telephone data transmitted between the user and the mobile communication network; and the operating system module is used for calling the network communication module by the processor unit and controlling network communication between the user and the mobile communication network.

According to the embodiments of the present invention, the communication between the user and the mobile communication network comprises voice communication or data communication.

According to the embodiments of the present invention, the remote transceiver unit establishes the wireless link for communication between the user and the mobile communication network with the mobile communication network according to the communication mode defined by the mobile communication network. The mobile communication network comprises one of the following communication systems: GSM (Global System for Mobile Communication), CDMA (Code Division Multiple Access) system, WCDMA (Wideband Code Division Multiple Access) system, CDMA 2000, TD-SCDMA (Time Division-Synchronization Code Division Multiple Access) system, WiFi (Wireless Fidelity) or WiMax (WiMAX).

According to the embodiments of the present invention, the communication link between the wireless transceiver and the local terminal equipment comprises at least one of the following communication links: a wireless communication link comprising a Bluetooth communication link or a infrared communication link; and a wire link connected by a network line, a telephone line or a USB (Universal Serial Bus) interface data line.

According to the embodiments of the present invention, the local terminal equipment comprises at least one of the following types: mobile phone, computer, PDA (Personal Digital Assistant) or MP4 (Media Player 4).

According to the embodiments of the present invention, when the local transceiver unit received the information of voice communication transmitted from the local terminal equipment, the remote transceiver unit forwards the information to the mobile communication network, and when the remote transceiver unit received voice communication data transmitted from the mobile communication network, forwards the received voice communication data to the local terminal equipment by the local transceiver unit; or

when the remote transceiver unit received the information of voice communication transmitted from the mobile communication network, the local transceiver unit forwards the information to the local terminal equipment, and when the local transceiver unit received voice communication data transmitted from the local terminal equipment, forwards the received voice communication data to the mobile communication network by the remote transceiver unit.

According to the embodiments of the present invention, when the local transceiver unit received the information of data communication of the user transmitted by the local terminal equipment, the remote transceiver unit forwards the information to the mobile communication network, and after receiving data communication data transmitted from the mobile communication network, the remote transceiver unit forwards the received data communication data to the local terminal equipment by the local transceiver unit; or when the remote transceiver unit received the information of data communication of the user transmitted by the mobile communication network, the local transceiver unit forwards the information to the local terminal equipment, and when the local transceiver unit received data communication data transmitted from the local terminal equipment, forwards the received data communication data to the mobile communication network by the remote transceiver unit.

The invention aims at leading the user to continuously use his favorite mobile terminal and to access different mobile communication systems rather than the limited local communication network by the usually-used mobile terminal with a smaller cost simultaneously by providing the unified communication platform for the user. Due to the technical solutions provided by the embodiments of the present invention, the present invention is good for the user to obtain the undifferentiated service and service quality in different communication systems without needing to change the existing communication system, not capable of affecting the compatibility of the system, and simple and high-efficiency in implementation.

Further aspects and advantages of the present invention will be given in the following description. They will become apparent from either the following description or the implementation of the present invention.

### BRIEF DESCRIPTION OF THE DRAWINGS

The above and/or further aspects and advantages of the present invention will be more fully understood from the following description of embodiments with reference to the drawings, in which:

FIG. 1 illustrates a structure diagram showing system configuration in accordance with one embodiment of the present invention;

FIG. 2 illustrates a flowchart showing a wireless communication method in accordance with the embodiment of the present invention;

FIG. 3 illustrates a structure diagram showing a wireless transceiver in accordance with another embodiment of the present invention;

FIG. 4 illustrates a flow-process sequence chart for telephoning by a local network in the method of the present invention;

FIG. 5 illustrates a flow-process sequence chart for telephoning by an extended network in a method of the present invention;

FIG. 6 illustrates a flow-process sequence chart for answering the phone by a local network in a method of the present invention;

FIG. 7 illustrates a flow-process sequence chart for answering the phone by an extended network in a method of the present invention;

FIG. 8 illustrates a flow-process sequence chart for connecting and disconnecting a data link in a method of the present invention; and

FIG. 9 illustrates a flow-process sequence chart of data communication in a method of the present invention.

### DETAILED DESCRIPTION OF THE PREFERRED EMBODIMENTS

The embodiments of the present invention will be detailed in the following. The exemplary embodiments are illustrated in the drawings, throughout which same or similar reference numerals refer to same or similar elements or to elements having same or similar functions. The following embodiments described with reference to the drawings are exemplary only for explaining, rather than limiting the present invention.

In order to achieve the aims of the present invention, the embodiments of the present invention provide a method for wireless communication. The method comprises the following steps: a wireless transceiver obtaining information of the user from a subscriber identification module (SIM) card when the user needs to connect with a mobile communication network; the wireless transceiver establishing a communication link with local terminal equipment to receive and transmit data of the user, and establishing a wireless communication link with the mobile communication network to receive and transmit the data of the user; and the wireless transceiver receiving data transmitted from the local terminal equipment, forwarding the data to the mobile communication network, receiving the data which is transmitted by the mobile communication network to the user, and forwarding the data to the local terminal equipment.

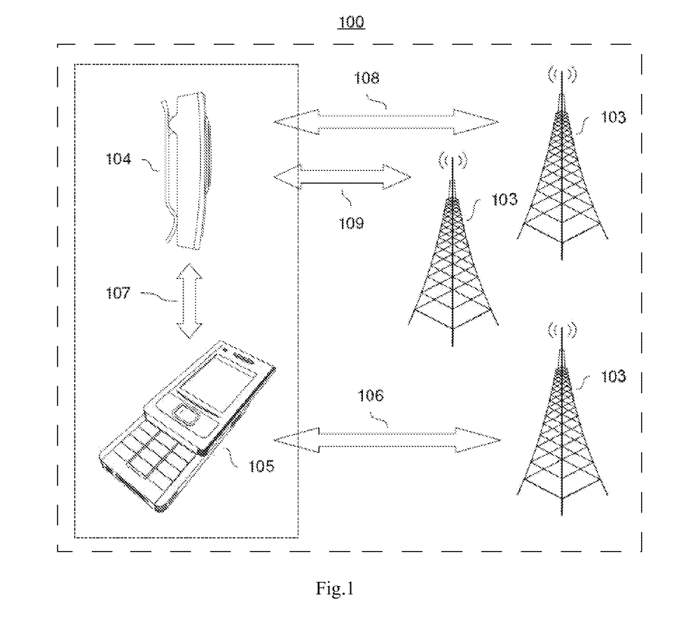

FIG. 1 is a structure diagram showing system configuration according to one embodiment of the present invention. Specifically, a system 100 comprises a mobile terminal 105, a base station 103 of the mobile communication network and a wireless transceiver, specifically, an extended mobile communication device 104. As shown in FIG. 1, the mobile terminal, specifically, a local terminal equipment 105 is in connection with the base station 103 by a local telephone communication link 106, and the extended mobile communication device 104 is in connection with the base station 103 by two far-end telephone communication links 108 and 109; and the extended mobile communication device 104 is communicated with the mobile terminal 105 by a local communication link 107. Due to this mode, the extended mobile communication device 104 provides a communication transmission channel for the mobile terminal 105 and the base station 103.

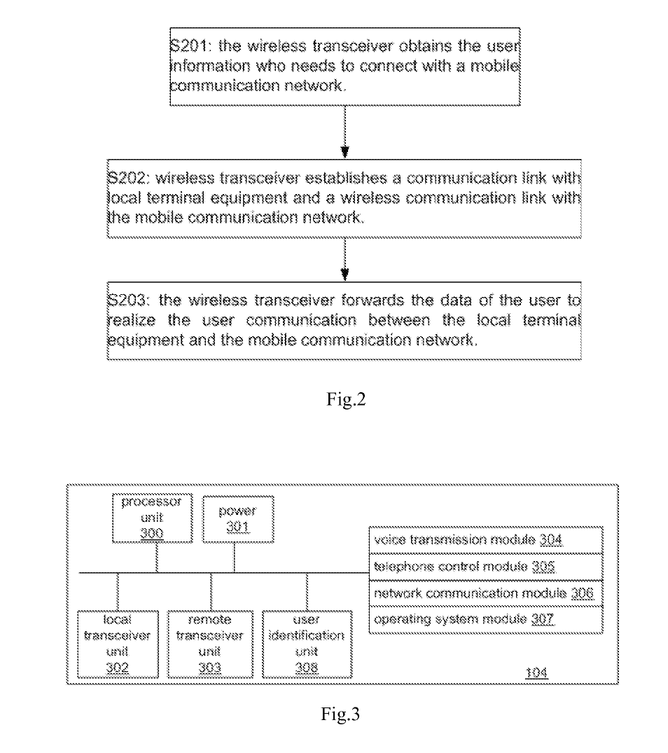

FIG. 2 is a flowchart showing the wireless communication method in an embodiment of the present invention, comprising the following steps:

S201: the wireless transceiver obtains the user information when the user needs to connect with a mobile communication network.

In step 201, the wireless transceiver obtains the information of the user from a SIM card when the user needs to connect with a mobile communication network. The existing mobile terminal usually has one or two cards, i.e. one telephone is only provided with one or two slots of the SIM card. In order to achieve the aims of the present invention, the wireless transceiver comprises a set of expansion slots used for connecting with at least one of SIM cards, and the wireless transceiver can obtain the user information from the subscriber identification module (SIM) cards when the user needs to connect with the mobile communication network.

S202: the wireless transceiver establishes a communication link with local terminal equipment and a wireless communication link with the mobile communication network.

In the step S202, the wireless transceiver establishes the communication link with the local terminal equipment to receive and transmit the data of the user, and the wireless communication link with the mobile communication network to receive and transmit the data of the user.

As an embodiment of the present invention, the mobile communication network comprises one of the following communication systems: GSM (Global System for Mobile Communication), CDMA (Code Division Multiple Access) system, WCDMA (Wideband Code Division Multiple Access) system, CDMA 2000, TD-SCDMA (Time Division-Synchronization Code Division Multiple Access) system, WiFi (Wireless Fidelity) or WiMax (WiMAX), so that the wireless transceiver establishes the corresponding wireless link with the mobile communication network according to a communication mode defined by the mobile communication network, and the wireless link is the wireless link for communication between the user identified by the SIM card and the mobile communication network. Obviously, the present invention is not limited to the communication network mentioned above and can also be applied to an evolution system LTE (Long Term Evolution) of a 3G (3rd Generation) system or a PHS (Personal Handphone System) system. For example, the wireless transceiver establishes the link in the manner of TDMA (Time Division Multiple Access) when the communication system is the GSM, and the wireless transceiver establishes the link in the manner of CDMA (Code Division Multiple Access) when the communication system is the CDMA, wherein the specific mode for establishing the link is realized according to the protocols of different communication systems. Furthermore, due to the technical solutions provided by the present invention, the terminal which is only communicated with one kind of the communication systems formerly can also access into the other communication systems, for example, the mobile phone with the CDMA system can access the GSM network by the wireless transceiver.

As the embodiment of the present invention, the communication link established between the wireless transceiver and the local terminal equipment comprises at least one of following communication links: a wireless communication link comprising Bluetooth communication link, infrared communication link or other short-distance close-quarter wireless communication mode; and a wire link connected by a network line, a telephone line or a USB (Universal Serial Bus) interface data line, etc.

Obviously, the local terminal equipment related in the present invention comprises but isn't limited to one or more of the following types: mobile phone, computer, PDA (Personal Digital Assistant), MP4 (Media Player 4), browser equipment, GPS (Global Positioning System) equipment or other multimedia terminal equipment.

S203: the wireless transceiver forwards the data of the user to realize the user communication between the local terminal equipment and the mobile communication network.

In the step S203, the wireless transceiver receives the data transmitted from the local terminal equipment and forwards the data to the mobile communication network, receives the data which is transmitted by the mobile communication network to the user and forwards the data to the local terminal equipment.

Wherein, the communication between the user and the mobile communication network comprises voice communication or data communication.

Specifically, after receiving information of the voice communication of the user transmitted from the local terminal equipment, the wireless transceiver forwards the information to the mobile communication network; and after receiving the voice communication data transmitted from the mobile communication network, the wireless transceiver forwards the data to the local terminal equipment; or

after receiving information of the voice communication of the user transmitted from the mobile communication network, the wireless transceiver forwards the information to the local terminal equipment; and after receiving the voice communication data transmitted from the local terminal equipment, the wireless transceiver forwards the data to the mobile communication network.

Specifically, after receiving information of the data communication of the user transmitted from the local terminal equipment, the wireless transceiver forwards the information to the mobile communication network; and after receiving the data communication data transmitted from the mobile communication network, the wireless transceiver forwards the data to the local terminal equipment; or

after receiving the information of the data communication of the user transmitted from the mobile communication network, the wireless transceiver forwards the information to the local terminal equipment; and after receiving the data communication data transmitted by the local terminal equipment, the wireless transceiver forwards the data to the mobile communication network.

Furthermore, the local terminal equipment outputs data which is transmitted by the mobile communication network to the user.

Specifically, for example, the user operates the local terminal equipment to establish the communication with the mobile communication network by an SIM card in the wireless transceiver, for example, answering or dialing a phone, initiating the data service such as internet surfing, etc.

Adopting the technical solution, the wireless transceiver, by providing the unified bottom communication platform for the user, leads the user to continuously use his favorite mobile terminal and to access different mobile communication systems by the usually-used mobile terminal with a smaller cost simultaneously, for example, the user, still by the former terminal equipment, can access a new communication network rather than the limited local communication network after inserting a new SIM card into the wireless transceiver.

Correspondingly, as shown in FIG. 3, embodiments of the present invention provide a wireless transceiver 104 comprising a user identification unit, a remote transceiver unit and a local transceiver unit.

Wherein, the user identification unit 308 comprises a set of expansion slots for connecting with at least one of SIM cards, and the user identification unit 308 is used for obtaining information of the user from the SIM cards when the user needs to connect with the mobile communication network.

The remote transceiver unit 303 is used for establishing the wireless link for communication between the user and the mobile communication network to receive and transmit the data of the user, and the wireless link carries the data for communication between the user and the mobile communication network.

The local transceiver unit 302 is used for establishing the communication link for communication between the wireless transceiver and the local terminal equipment to receive and transmit the data of the user, and the communication link carries the data for communication between the user and the mobile communication network.

As the embodiments of the equipment, the wireless transceiver further comprises a processor unit 300 and a control unit, wherein the control unit comprises an operating system module 307, a voice transmission module 304, a telephone control module 305 and a network communication module 306.

The operating system module 307 with the beneficial of the processor 300 unit, is used for calling the voice transmission module 304 and controlling voice data transmitted between the user and the mobile communication network; the operating system module 307 with the beneficial of by the processor 300 unit, is used for calling the telephone control module 305 and controlling telephone data transmitted between the user and the mobile communication network; and the operating system module 307 with the beneficial of the processor 300 unit, is used for calling the network communication module 306 and controlling network communication between the user and the mobile communication network.

As the embodiments of the equipment mentioned above, the communication between the user and the mobile communication network comprises voice communication or data communication.

As the embodiments of the equipment mentioned above, the remote transceiver unit 303 establishes the wireless link for communication between the user and the mobile communication network according to the communication mode defined by the mobile communication network. The mobile communication network comprises one of the following communication systems: GSM (Global System for Mobile Communication), CDMA (Code Division Multiple Access) system, WCDMA (Wideband Code Division Multiple Access) system, CDMA 2000, TD-SCDMA (Time Division-Synchronization Code Division Multiple Access) system, WiFi (Wireless Fidelity) or WiMax (WiMAX). Specifically, the wireless transceiver 104 establishes the corresponding wireless link with the mobile communication network according to a communication mode defined by the mobile communication network, and the wireless link is for the communication between the user identified by the SIM card and the mobile communication network. Obviously, the present invention is not limited to the communication network listed above and can also be applied to an evolution system LTE (Long Term Evolution) of a 3G (3rd Generation) system or a PHS (Personal Handphone System) system. For example, the wireless transceiver establishes the link in the manner of TDMA (Time Division Multiple Access) when the communication system is the GSM, and the wireless transceiver 104 establishes the link in the manner of CDMA (Code Division Multiple Access) when the communication system is the CDMA, wherein the specific mode for establishing the link is realized according to the protocols of different communication systems. Furthermore, due to the technical solutions provided by the present invention, the terminal which is only communicated with some communication systems formally can also access into the other communication systems, for example, the mobile phone with CDMA system can access the network of GSM by the wireless transceiver 104. As an embodiment of the equipment, the communication link established between the wireless transceiver and the local terminal equipment comprises at least one of following communication links: a wireless communication link comprising Bluetooth communication link or infrared communication link; and a wire link connected by a network line, a telephone line or a USB (Universal Serial Bus) interface data line.

As the embodiments of the present invention mentioned above, the local terminal equipment comprises at least one of the following types: mobile phone, computer, PDA (Personal Digital Assistant) or MP4 (Media Player 4), browser equipment, GPS (Global Position System) equipment or the multimedia terminal equipment.

As the embodiments of the equipment mentioned above, when the local transceiver unit 302 received information of the voice communication of the user transmitted from the local terminal equipment, the remote transceiver unit 303 forwards the information to the mobile communication network; and after receiving the voice communication data transmitted from the mobile communication network, the remote transceiver unit 303 forwards the data to the local terminal equipment by the local transceiver unit 302; or

When the remote transceiver unit 303 received information of the voice communication of the user transmitted from the mobile communication network, the local transceiver unit 302 forwards the information to the local terminal equipment; and after receiving the voice communication data transmitted by the local terminal equipment, the transceiver unit 302 forwards the data to the mobile communication network by the remote transceiver unit 303.

As the embodiments of the equipment mentioned above, when the local transceiver unit 302 received the information of data communication of the user transmitted from the local terminal equipment, the remote transceiver unit 303 forwards the information to the mobile communication network; and after receiving the data communication data transmitted from the mobile communication network, the remote transceiver unit 303 forwards the data to the local terminal equipment by the local transceiver unit 302; or when the remote transceiver unit 303 received the information of data communication of the user transmitted from the mobile communication network, the local transceiver unit 302 forwards the information to the local terminal equipment; and after receiving the data communication data transmitted from the local terminal equipment, the local transceiver unit 302 forwards the data to the mobile communication network by the remote transceiver unit 303.

Preferably, the mentioned equipment further can comprise a power source 301, obviously, further can be an external power source, and for example, the power can be supplied by a USB data line.

The equipment of the present invention is simple in structure, small and exquisite in appearance, can be put in a pocket and a briefcase, and can realize the instant communication by keeping a certain distance from the local terminal.

In order to further illustrate the present invention, the application of the technical solution of the present invention in some scene is further illustrated with reference to the drawings.

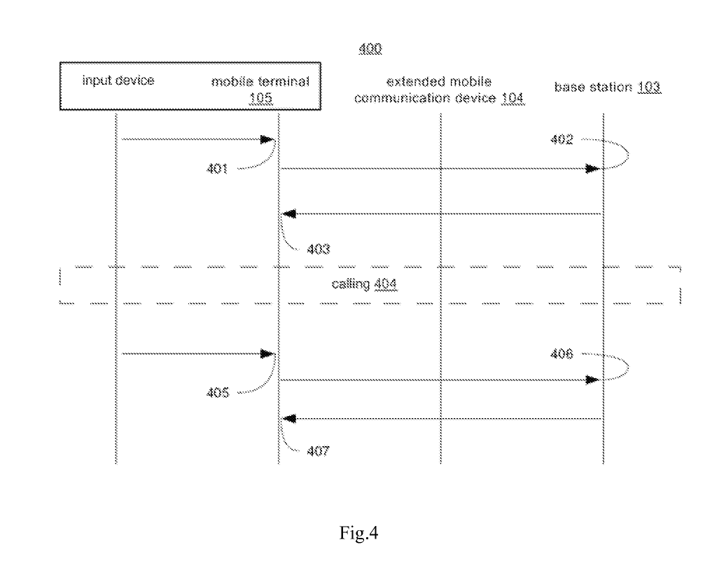

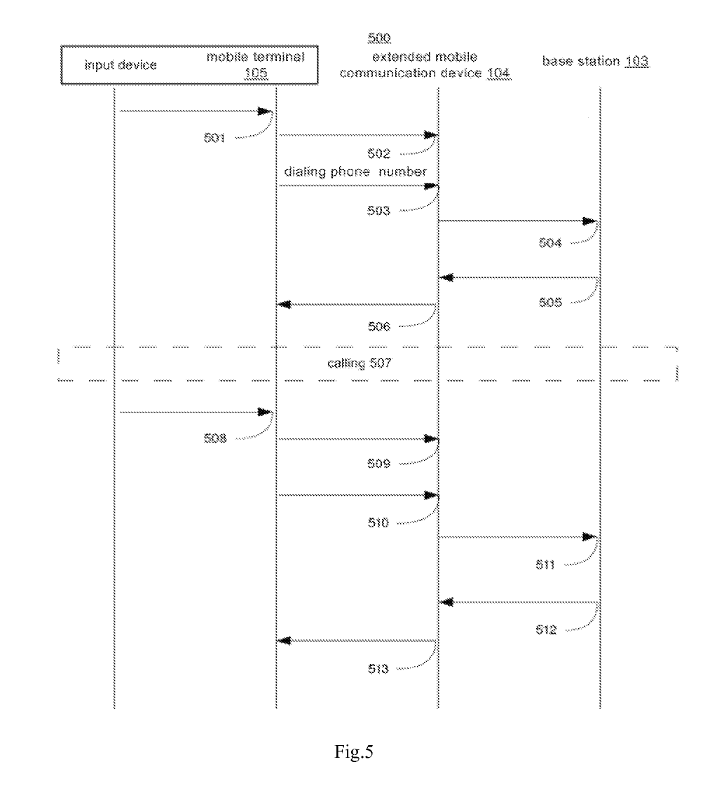

FIG. 4 is a flow-process sequence chart for telephoning by a local network in a method of the present invention; and in order to be convenient to illustrate the present invention, an input module of the mobile terminal is separated in the figure, but usually the input module in a specific mobile terminal is an inbuilt part or a connectable part, such as a keyboard.

A process 400 for calling a local network telephone comprises the following steps of:

(401) dialing by the input module of the mobile terminal;

(402) asking for getting through from the mobile terminal to a local base station;

(403) transmitting a calling link getting through feedback by the local base station to the mobile terminal;

(404) calling;

(405) ringing off by the input module of the mobile terminal;

(406) asking for ringing off from the mobile terminal to the local base station; and

(407) transmitting a calling link stopping feedback from the local base station to the mobile terminal.

FIG. 5 is a flow-process sequence chart for telephoning by an extended network in the method of the present invention;

A process 500 for dialing the extended network telephone comprises the following steps of:

(501) dialing by the input module of the mobile terminal;

(502) transmitting a communication network selecting instruction from the mobile terminal to the extended mobile communication device;

(503) dialing the wireless communication telephone of the selected network by the extended mobile communication device;

(504) asking for getting through from the extended mobile communication device to the selected base station;

(505) transmitting a calling link getting through feedback from the selected base station to the extended mobile communication device;

(506) transmitting a voice signal from the extended mobile communication device to the mobile terminal;

(507) calling;

(508) ringing off by the input module of the mobile terminal;

(509) transmitting an instruction for selecting the communication network from the mobile terminal to the extended mobile communication device;

(510) transmitting an instruction for asking for ringing off from the mobile terminal to the extended mobile communication device;

(511) asking for ringing off from the extended mobile communication device to the selected base station;

(512) transmitting a calling link stopping feedback from the selected base station to the extended mobile communication device; and

(513) stopping transmitting the voice signal from the extended mobile communication device to the mobile terminal.

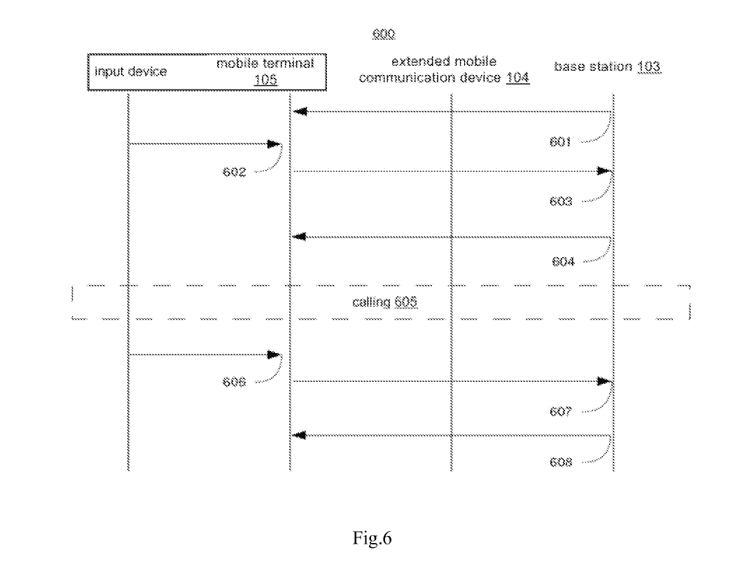

FIG. 6 is a flow-process sequence chart for answering the phone by a local network in the method of the present invention;

A process 600 for accessing a local network telephone comprises the following steps of:

(601) transmitting a getting through request from the local base station to the mobile terminal through the local communication network;

(602) answering by the input module of the mobile terminal;

(603) transmitting an instruction for receiving the telephone from the mobile terminal to the local base station;

(604) transmitting a calling link getting through feedback from the local base station to the mobile terminal;

(605) calling;

(606) ringing off by the input module of the mobile terminal;

(607) asking for ringing off from the mobile terminal to the local base station; and

(608) transmitting a calling link stopping feedback from the local base station to the mobile terminal.

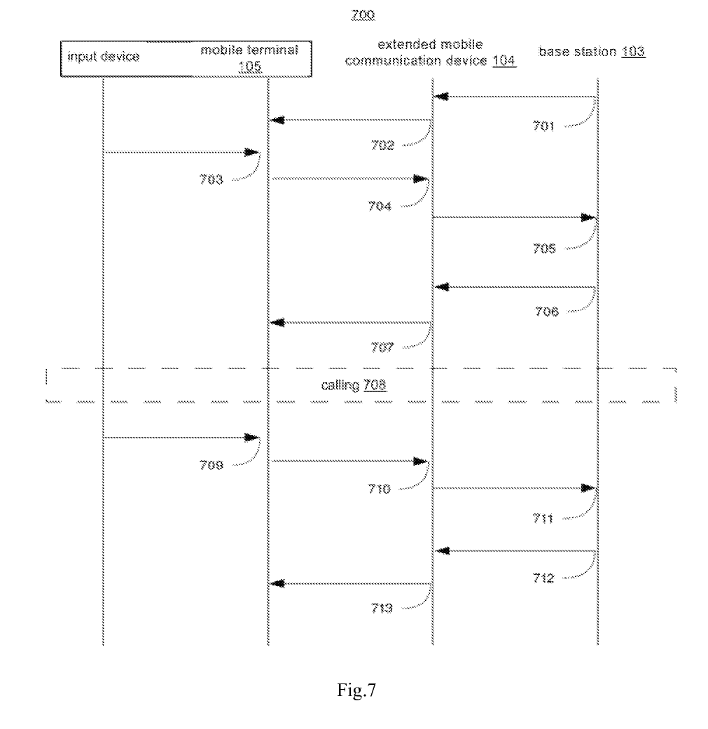

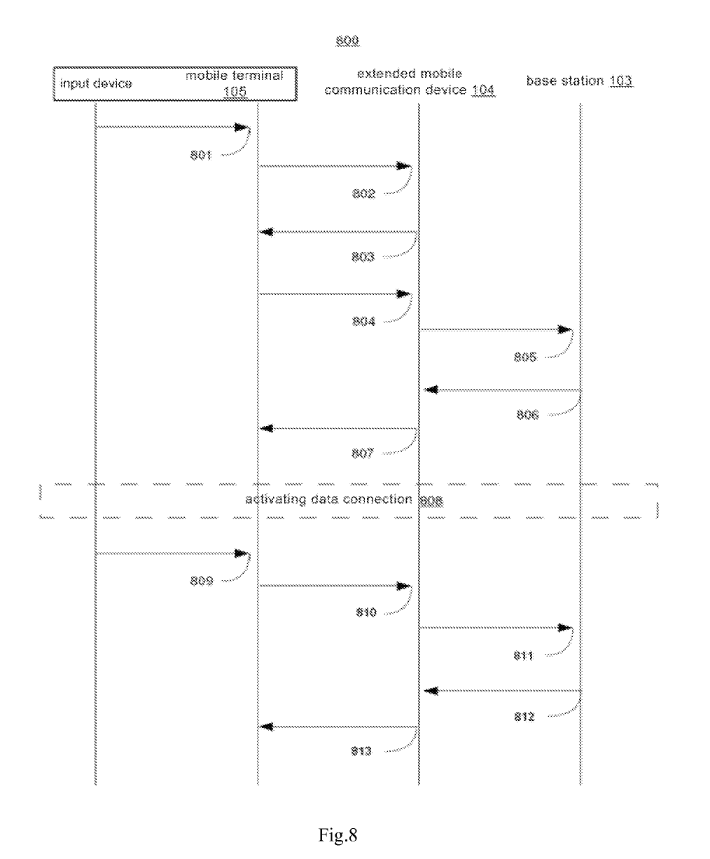

FIG. 7 is a flow-process sequence chart for answering the phone by an extended network in the method of the present invention;

A process 700 for getting through an extended network telephone comprises the following steps of:

(701) transmitting a calling getting through request from an extended base station to a extended mobile communication device through the communication network;

(702) informing the mobile terminal of calling by the extended mobile communication device;

(703) answering by the input module of the mobile terminal;

(704) transmitting an instruction for receiving the call from the mobile terminal to the extended mobile communication device;

(705) transmitting a request for receiving the call from the extended mobile communication device to the base station;

(706) transmitting a calling link getting through feedback from the base station to the extended mobile communication device;

(707) transmitting a voice signal from the extended mobile communication device to the mobile terminal;

(708) calling;

(709) ringing off by the input module of the mobile terminal;

(710) transmitting an instruction for ringing off from the mobile terminal to the extended mobile communication device;

(711) asking for ringing off from the extended mobile communication device to the base station;

(712) transmitting a calling link stopping feedback from the base station to the extended mobile communication device; and

(713) stopping transmitting the voice signal from the extended mobile communication device to the mobile terminal.

FIG. 8 is a flow-process sequence chart for connecting and disconnecting a data link in the method of the present invention;

A process for connecting and disconnecting the data transmission link during completing the data communication comprises:

A process 800 for connecting the data transmission link, comprising the following steps of:

(801) triggering data connection by the input module of the mobile terminal;

(802) transmitting an instruction for triggering a data processing and applying system (SAP) from the mobile terminal to the extended mobile communication device;

(803) feeding back an SAP reaction from the extended mobile communication device to the mobile terminal;

(804) transmitting an instruction for network connection from the mobile terminal to the extended mobile communication device by Bluetooth;

(805) making a request for data connection from the extended mobile communication device to the base station;

(806) feeding back an instruction for data link connection by the base station;

(807) configuring data information from the extended mobile communication device to the mobile terminal;

(808) activating the data link;

A process for disconnecting the data transmission link comprises the following steps of:

(809) triggering a data disassembling instruction by the input module of the mobile terminal;

(810) transmitting a Bluetooth connection network stopping instruction from the mobile terminal to the extended mobile communication device;

(811) making a request for stopping data connection from the extended mobile communication device to the base station;

(812) feeding back an instruction for stopping connecting the data link by the base station; and

(813) ending network communication.

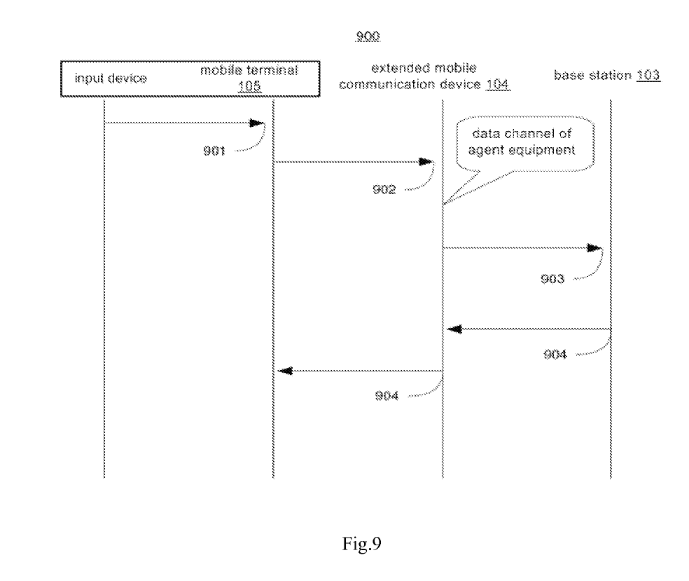

FIG. 9 is a flow-process sequence chart of data communication in the method of the present invention.

A process 900 for activating the data link comprises the following steps of:

(901) asking for data connection by the input module of the mobile terminal;

(902) asking for network connection from the mobile terminal to the extended mobile communication device by the Bluetooth;

(903) distributing a data transmission path by an operation module of the extended mobile communication device;

(904) transmitting a data communication request from the extended mobile communication device to the base station;

(905) feeding back a data communication signal by the base station; and

(906) transmitting data information from the extended mobile communication device to the mobile terminal by the Bluetooth.

The technical solution provided by the embodiments of the present invention, by providing a unified bottom communication platform for the user, leads the user to continuously use his favorite mobile terminal and to access different mobile communication systems rather than the limited local communication network by the usually-used mobile terminal with a smaller cost simultaneously. Furthermore, a chip or a module which is communication with a new network is arranged on the equipment provided by the technical solution of the present invention when a system network is updated or upgraded by an operator, so that the user can access the new network by the formerly-used terminal, therefore, the expenditure of the user can be saved, and the smooth transition of a user group can be preferably performed when the system network is updated or upgraded by the operator. The technical solutions provided by the embodiments of the present invention are good for the user to obtain the undifferentiated service and service quality in different communication systems without needing to change the existing communication system, not capable of affecting the compatibility of the system, and simple and high-efficiency in implementation. The common technical personnel in the field can understand that all or some steps in the embodiments can be completed by the means that relevant hardware is instructed by a program, the program can be stored in a computer readable storage medium, and the program comprises any one or combination of the steps in the embodiments when being executed.

Furthermore, each function unit in each embodiment of the present invention can be integrated in one process module, or each unit can independently and physically exist, or at least two of the units can be integrated in one module. The integrated module not only can be realized in the manner of hardware but also can be realized in the manner of a software function module. The integrated module further can be stored in a computer readable storage medium if being realized in the manner of the software function module and sold or used as an independent product.

The storage medium can be a ROM (read only memory), a magnetic disc or an optical disc, etc.

The content mentioned only describes the preferable embodiments of the present invention, it should be pointed out that any improvement and deformation made by the person skilled in the art under the spirit of the present patent invention belongs to the protection range of the present invention.

1. A method for wireless communication, comprising the following steps:
a wireless transceiver obtaining user information from a SIM card when the user needs to connect with a mobile communication network;
the wireless transceiver establishing a communication link with a local terminal equipment to receive and transmit data of the user, and establishing a wireless communication link with the mobile communication network to receive and transmit the data of the user; and
the wireless transceiver receiving data transmitted from the local terminal equipment and forwarding the data to the mobile communication network, and receiving the data transmitted from the mobile communication network to the user and forwarding the data to the local terminal equipment.

2. The method for wireless communication according to claim 1, wherein the communication between the user and the mobile communication network comprises voice communication or data communication.

3. The method for wireless communication according to claim 2, wherein the mobile communication network comprises one of the following communication systems: GSM, CDMA, WCDMA, CDMA 2000, TD-SCDMA, LTE, TD-LTE, WiFi or WiMAX; and the wireless transceiver establishes a wireless link for communication between the user and the mobile communication network according to a communication mode defined by the mobile communication network.

4. The method for wireless communication according to claim 3, wherein the communication link established between the wireless transceiver and the local terminal equipment comprises at least one of following communication links:
a wireless communication link comprising Bluetooth communication link, WiFi link or infrared communication link; and a wire link connected by a network line, a telephone line, or a USB interface data line.

5. The method for wireless communication according to claim 4, wherein the local terminal equipment comprises at least one of the following types: mobile phone, computer, Pads, Tablets, PDA or MP4.

6. The method for wireless communication according to claim 5, wherein the wireless transceiver forwards information of the voice communication of the user transmitted from the local terminal equipment to the mobile communication network after receiving the information of the voice communication; and forwards a voice communication data transmitted from the mobile communication network to the local terminal equipment after receiving the voice communication data; or
the wireless transceiver forwards information of voice communication of the user transmitted from the mobile communication network to the local terminal equipment after receiving the information of voice communication; and forwards a voice communication data transmitted from the local terminal equipment to the mobile communication network after receiving the voice communication data.

7. The method for wireless communication according to claim 6, wherein
the wireless transceiver forwards information of data communication of the user transmitted from the local terminal equipment to the mobile communication network after receiving the information of data communication; and forwards a data communication data transmitted from the mobile communication network to the local terminal equipment after receiving the data communication data; or
the wireless transceiver forwards the information of data communication the user transmitted from the mobile communication network to the local terminal equipment after receiving the information of data communication; and forwards the data communication data transmitted from the local terminal equipment to the mobile communication network after receiving the data communication data.

8. The method for wireless communication according to claim 6 or 7, wherein the local terminal equipment outputs data which is transmitted from the mobile communication network to the user.

9. A wireless transceiver comprising a user identification unit, a remote transceiver unit and a local transceiver unit, wherein
the user identification unit comprises a set of expansion slots for connecting with at least one of SIM cards, and is used for obtaining the user information from the SIM cards when the user needs to connect with a mobile communication network;
the remote transceiver unit is used for establishing the wireless link for communication between the user and the mobile communication network to receive and transmit the data of the user, and the wireless link carries data for communication between the user and the mobile communication network; and
the local transceiver unit is used for establishing the communication link for communication between the wireless transceiver and the local terminal equipment to receive and transmit the data of the user, and the communication link carries the data for communication between the user and the mobile communication network.

10. The wireless transceiver according to claim 9, further comprising a processor unit and a control unit, wherein the control unit comprises an operating system module, a voice transmission module, a telephone control module and a network communication module; wherein
the operating system module is used for calling the voice transmission module by the processor unit and controlling voice data transmitted between the user and the mobile communication network; the operating system module is used for calling the telephone control module by the processor unit and controlling telephone data transmitted between the user and the mobile communication network; and the operating system module is used for calling the network communication module by the processor unit and controlling network communication between the user and the mobile communication network.

11. The wireless transceiver according to claim 10, wherein the communication between the user and the mobile communication network comprises voice communication or data communication.

12. The wireless transceiver according to claim 9, wherein the remote transceiver unit establishes the wireless link for communication between the user and the mobile communication network according to the communication mode defined by the mobile communication network, and the mobile communication network comprises one of the following communication systems: GSM, CDMA, WCDMA, CDMA 2000, TD-SCDMA, LTE, TD-LTE, WiFi or WiMax.

13. The wireless transceiver according to claim 12, wherein the communication link between the wireless transceiver and the local terminal equipment comprises at least one of the following communication links:
a wireless communication link comprising Bluetooth communication link, WiFi link, or infrared communication link; and a wire link connected by network line, telephone line or USB interface data line.

14. The wireless transceiver according to claim 13, wherein the local terminal equipment comprises at least one of the following types: mobile phone, computer, PDA or MP4.

15. The wireless transceiver according to claim 14, wherein
the remote transceiver unit forwards the information of voice communication of the user to the mobile communication network when the local transceiver unit received the information of voice communication from the local terminal equipment; and forwards a voice communication data transmitted from the mobile communication network to the local terminal equipment by the local transceiver unit after receiving the voice communication data; or
the local transceiver unit forwards information of voice communication of the user to the local terminal equipment when the remote transceiver unit received the information of voice communication from the mobile communication network; and forwards a voice communication data transmitted from the local terminal equipment to the mobile communication network by the remote transceiver unit after receiving the voice communication data.

16. The wireless transceiver according to claim 14, wherein
the remote transceiver unit forwards information of data communication of the user to the mobile communication network when the local transceiver unit received the information of data communication from the local terminal equipment; and forwards a data communication data transmitted from the mobile communication network to the local terminal equipment by the local transceiver unit after receiving the data communication data; or
the local transceiver unit forwards information of data communication of the user transmitted from the mobile communication network to the local terminal equipment when the remote transceiver unit received the information of data communication; and forwards a data communication data transmitted from the local terminal equipment to the mobile communication network by the remote transceiver unit after receiving the data communication data.
